(19) United States
(12) Patent Application Publication
(10) Pub. No.: US 2009/0025684 A1
(43) Pub. Date: Jan. 29, 2009

(54) SYSTEM, METHOD AND COMPUTER READABLE MEDIA FOR CONTROLLING AT LEAST ONE FUEL DELIVERY CHARACTERISTIC DURING A COMBUSTION EVENT WITHIN AN ENGINE

(76) Inventors: Wolfgang Daum, Erie, PA (US); Paul Flynn, Fairview, PA (US); Samar Soliman, Marietta, GA (US); Kyle Craig Stott, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/022,482

(22) Filed: Jan. 30, 2008

Related U.S. Application Data
(60) Provisional application No. 60/952,416, filed on Jul. 27, 2007.

(51) Int. Cl. F02M 63/00

(52) U.S. Cl. 123/447; 701/103

(57) ABSTRACT

A system is provided for controlling at least one fuel delivery characteristic during a combustion event within an engine. The system includes an accumulator having a variable volume, where the accumulator is configured to hold fuel at a variable pressure based on the variable volume. The system further includes a combustion chamber coupled to the accumulator. The variable volume is varied during the combustion event such that at least one fuel delivery characteristic of the fuel delivered from the accumulator into the combustion chamber is varied during the combustion event. A method and computer readable media are also provided for controlling at least one fuel delivery characteristic during a combustion event within an engine.

### CROSS-REFERENCE TO RELATED APPLICATIONS

This application claims priority from U.S. Provisional Application No. 60/952,416, filed on Jul. 27, 2007, which is incorporated herein in its entirety.

### BACKGROUND OF THE INVENTION

The invention relates to the field of fuel injection systems, and more particularly, to a system and method for controlling at least one fuel delivery characteristic during a combustion event within an engine.

A conventional common rail fuel injection system 110 is illustrated in FIG. 1. This conventional fuel injection system 110 includes a tank 111 for holding fuel 120, a pump or series of pumps 115 to pressurize the fuel 120 prior to delivering the fuel to a combustion chamber 122 at a high pressure. These pumps 115 may include a high-pressure common rail fuel pump, for example. An accumulator 114 having a fixed volume 116 is also included, and receives the fuel 120 which is held in the accumulator 114 at a fixed pressure based on the fixed volume 116. A single-acting injector valve 132 is disposed between the accumulator 114 and a combustion chamber 122 at a fixed position 134, based on the fixed pressure of the fuel 120 within the accumulator 114. FIG. 2 illustrates a plot of three combustion events 126,128,130 in which the fuel 120 having the fixed pressure is delivered to the combustion chamber 122 through the single-acting injector valve 132. For each combustion event 126,128,130, which have respective durations (in degrees of crankshaft rotation) of 127,129,131, the volumetric flow 124 of fuel 120 into the combustion chamber 122 is a fixed amount 133. The rate of change of volumetric flow 124 of fuel 120 into the combustion chamber 122 during the combustion events 126,128,130 is zero, represented by the zero slope of the volumetric flow plot during the combustion events 126,128,130. Additionally, the rate of change of the volumetric flow 124 of fuel into the combustion chamber 122 experiences a sudden increase and decrease at the respective beginning and end portions 136,138 of a combustion event 128. This sudden variation in the rate of change of the volumetric flow 124 of fuel may damage the engine 12 and reduce its overall lifespan.

Thus, conventional fuel injection systems only permit a volumetric flow of fuel at a fixed amount, based on the fixed volume and pressure of the accumulator. This has several drawbacks, such as an inability to control the volumetric flow of fuel into the combustion chamber, so to control the emissions output of the engine based on an emission restriction, for example. Accordingly, it would be advantageous to provide a fuel injection system which permits adjustable variance of the maximum volumetric flow of fuel into the combustion chamber and the adjustable variance of the rate of change of volumetric flow of fuel into the combustion chamber, to optimize several operating characteristics of the engine.

### BRIEF DESCRIPTION OF THE INVENTION

One embodiment of the present invention provides a system for controlling one or more fuel delivery characteristics during a combustion event within an engine of a locomotive, off highway vehicle, marine diesel or stationary diesel power plant. The system includes an accumulator having a variable volume, where the accumulator is configured to hold fuel at a variable pressure based on the variable volume. Additionally, the system includes a combustion chamber coupled to the accumulator. The variable pressure is varied during the combustion event such that one or more fuel delivery characteristics of the fuel delivered from the accumulator into the combustion chamber is varied during the combustion event.

Another embodiment of the present invention provides a method for controlling one or more fuel delivery characteristics during a combustion event within an engine of a locomotive, off highway vehicle, marine diesel or stationary diesel power plant. The method includes configuring an accumulator with a variable volume, such that the accumulator is configured to hold fuel at a variable pressure based on the variable volume. Additionally, the method includes coupling a combustion chamber to the accumulator. The method further includes varying the variable volume during the combustion event, and varying one or more fuel delivery characteristics of the fuel delivered from the accumulator into the combustion chamber during the combustion event.

Another embodiment of the present invention provides a computer readable medium containing program instructions for controlling one or more fuel delivery characteristics during a combustion event within an engine. An accumulator is configured with a variable volume, such that the accumulator is coupled to a combustion chamber and is configured to hold fuel at a variable pressure based on the variable volume. An injector valve is positioned between the accumulator and the combustion chamber. Additionally, a controller is coupled to the accumulator and the injector valve. The computer readable medium includes a computer program code for varying the position of the injector valve to adjust a variable rate of volumetric flow of fuel from the accumulator to the combustion chamber. The computer readable medium further includes a computer program code for varying the variable volume and variable pressure of fuel within the accumulator to adjust the variable rate of volumetric flow of fuel from the accumulator to the combustion chamber.

### BRIEF DESCRIPTION OF THE DRAWINGS

A more particular description of the invention briefly described above will be rendered by reference to specific embodiments thereof that are illustrated in the appended drawings. These drawings depict only typical embodiments of the invention and are not therefore to be considered to be limiting of its scope.

FIG. 1 is a schematic view of a conventional common rail fuel injection system;

FIG. 2 a plot of the volumetric flow of fuel during three combustion events of the conventional common rail fuel injection system illustrated in FIG. 1;

FIG. 3 is a schematic view of an exemplary embodiment of a system for controlling at least one fuel delivery characteristic during a combustion event within an engine of a locomotive;

FIG. 4 is a plot of the volumetric flow of fuel during three combustion events of the system illustrated in FIG. 3;

FIG. 5 is a schematic view of an exemplary embodiment of a system for controlling at least one fuel delivery characteristic during a combustion event within an engine of a locomotive; and

FIG. 6 is a flow chart illustrating an exemplary embodiment of a method for controlling at least one fuel delivery characteristic during a combustion event within an engine of a locomotive.

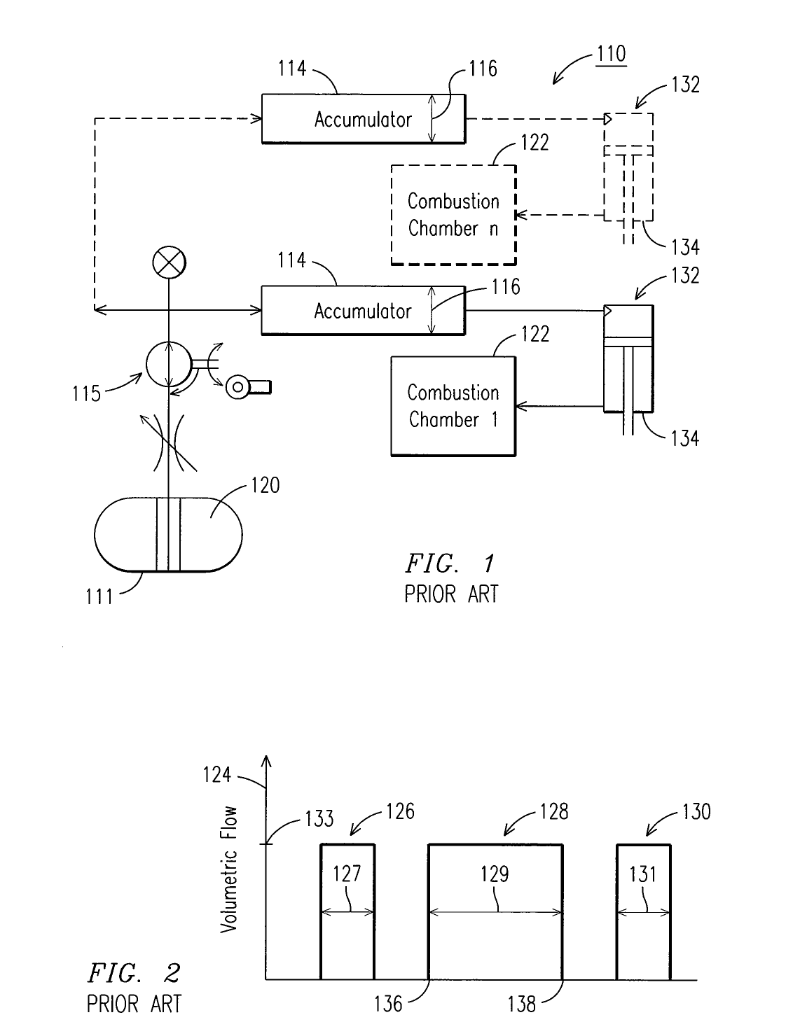

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

The embodiments of the present invention discuss systems and methods for controlling at least one fuel delivery characteristic during a combustion event within an engine. For example, a high-pressure fuel injection system and method is disclosed that regulates such fuel delivery characteristics as fuel flow rate, volume, flame propagation time, initial flame temperature, flame temperature change over time, combustion pressure over time and combustion gaseous emissions. The embodiments of the system of the present invention allow for the precise control of the combustion event in reciprocating engines through a continually variable transducer that modifies the fluid flow characteristics of a mechanical fuel injector system. Some advantages of the embodiments of the system and method of the present invention include decreased fuel consumption per HP*Hr, decreased post combustion emissions (NOx), and increased injector reliability, for example. Other notable advantages of the embodiments of the system and method of the present invention include an increased injector life through limiting pilot and post injection events due to the enhanced control resolution on the main injection event as provided by the variable accumulator volume. Additionally, the embodiments of the system and method of the present invention further provide a reduction of the mechanical injector tip temperature due to flow rate shaping and combustion chamber dynamics

The embodiments of the present invention encompass the dynamic control of fuel delivery characteristics, such as injection pressure, fluid flow, and fluid temperature, for example, by the addition of control surfaces to the typical common rail injection system. The efficiency and the volume of post combustion emissions are dependant on the interactions of the combustion characteristics.

FIG. 3 illustrates an exemplary embodiment of a system 10 for controlling a fuel delivery characteristic, such as a volumetric flow 24 of fuel 20, for example, during a combustion event 26,28,30 within an engine 12 of a locomotive. The system 10 includes a fuel tank 11 for delivering fuel 20 at high pressure to an accumulator 14, using a series of pumps 15 and a restriction valve 13, as appreciated by one of skill in the art. Although the embodiments of the present invention discuss a system as it relates to locomotive engines, the embodiments of the present invention may be utilized with any engine which employs a high-pressure accumulator and combustion chamber such as in Off Highway vehicles, marine and stationary power applications. As illustrated in FIG. 3, the system 10 includes an accumulator 14 having a variable volume 16. The variable volume 16 of the accumulator may be accomplished by expanding the dimensions of the accumulator 14, or may be accomplished by simply opening internal valves or otherwise opening up internal volume without expanding the outer dimensions of the accumulator 14, for example. The accumulator 14 is configured to hold fuel 20 at a variable pressure based on the variable volume 16. Also, as illustrated in FIG. 3, a combustion chamber 22 is coupled to the accumulator 14, and once the variable pressure of the fuel 20 is varied within the accumulator 14 during a combustion event 26,28,30, the volumetric flow 24 of the fuel 20 from the accumulator 14 into the combustion chamber 22 is varied during the combustion event 26,28,30.

FIG. 3 further illustrates that the system 10 includes an injector valve 32 positioned between the accumulator 14 and the combustion chamber 22. The injector valve 32 is configured to vary a rate of the volumetric flow 24 of fuel 20 from the accumulator 14 into the combustion chamber 22 based on a position 34 of the injector valve 32 relative to the accumulator 14. Additionally, the position 34 of the injector valve 32 may determine the droplet size of the fuel 20 entering the combustion chamber 22, for example. In one exemplary embodiment of the system 10, the position 34 of the injector valve 32 relative to the accumulator 14 is variable based on the variable pressure of the fuel 20 within the accumulator 14. Thus, in the exemplary embodiment, by adjusting the variable volume 16 of the accumulator 14, the variable pressure, the volumetric flow 24 rate of fuel 20 into the combustion chamber 22, and the rate of the volumetric flow 24 of fuel into the combustion chamber 22 is correspondingly adjusted.

In one exemplary embodiment the variable volume, variable pressure and variable delivery is accomplished by at least one piezo electric device that is coupled to the engine control system.

In another exemplary embodiment fuel pressure wave shaping is accomplished by time variant activation of at least one pieze electric device coupled to the engine controller that changes the fuel flow characteristics and delivery to the combustion event.

In another embodiment of the present invention, a variable area or variable volume may be mechanically controlled by a conventional spring/damper system. In this embodiment, the variable geometry injection system is not actively controlled but does provide the capability to control the flow rate more accurately that a conventional system.

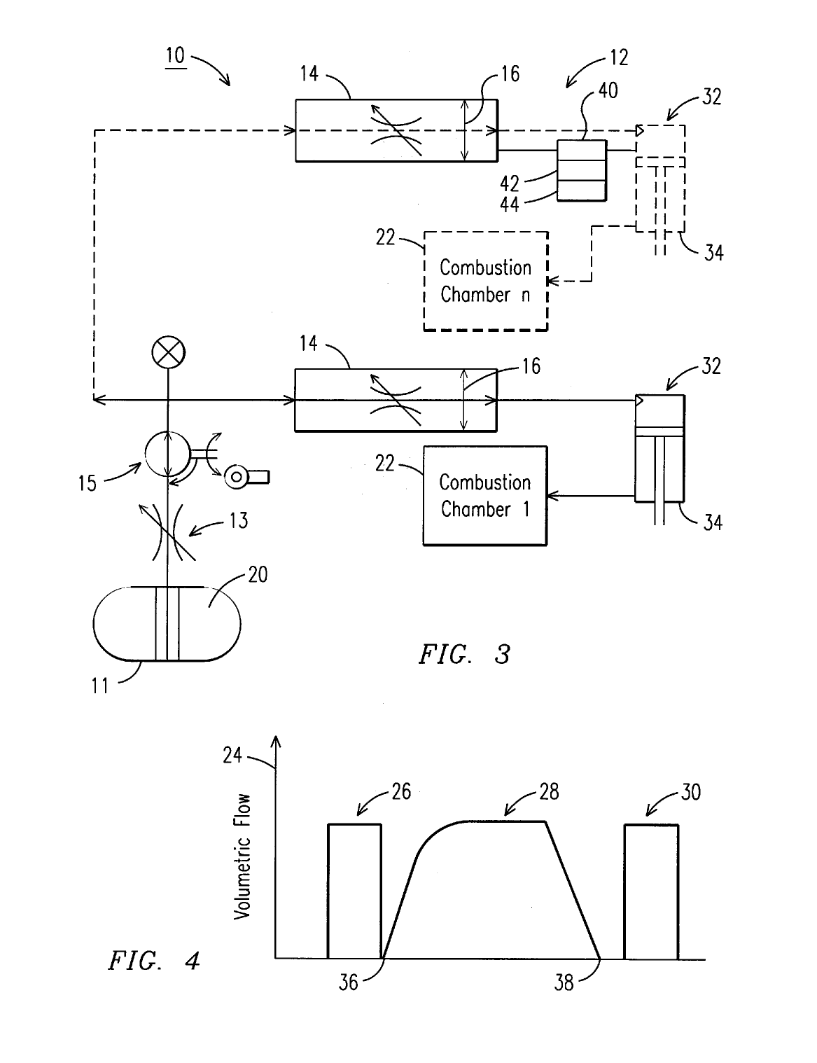

FIG. 4 illustrates an exemplary embodiment of a plot sequence of the volumetric flow 24 rate of fuel 20 into the combustion chamber 22 during several combustion events 26,28,30. By dynamically varying the variable volume 16 and fixing the position 34 of the injector valve 32 or dynamically varying the position 34 of the injector valve 32 and fixing the variable volume 16 during the middle combustion event 28, the variable pressure and the rate of volumetric flow 24 of fuel 20 from the accumulator 14 to the combustion chamber 22 is adjustably varied during the combustion event 28. This adjustable variance of the volumetric flow 24 rate is apparent by the varying slope of the volumetric flow 24 rate at a beginning portion 36 (i.e., slope of the plot flattens out toward the center of the combustion event 28) of the combustion event 28. Unlike the corresponding combustion event 128 (FIG. 2) of the conventional system 110, where the volumetric flow 124 of fuel 120 is constant and the rate of the volumetric flow 124 of fuel 120 into the combustion chamber 122 is zero, both the volumetric flow 24 of fuel 20 and the rate of the volumetric flow 24 of fuel 20 are varied during the combustion event 28. This adjustable variance allows for numerous ways to control the volumetric flow 24 of fuel 20 into the combustion chamber 22. In an example, the volumetric flow 24 of fuel 20 and the rate of volumetric flow 24 of fuel 20 may be adjustably varied at a beginning 36 and an end 38 portion of the combustion event 28 such that the rate of volumetric flow 24 of fuel 20 is less than a maximum threshold flow rate.

As illustrated in the exemplary embodiment of FIG. 3, the system 10 further includes a sensor 42 configured to sense an operating parameter of the locomotive. Additionally, the system 10 includes a controller 40 coupled to the sensor 42, the accumulator 14 and the injector valve 32. The controller 40 is configured to vary the position 34 of the injector valve 32 based upon the operating parameter to adjust a variable rate of volumetric flow 24 of fuel 20 from the accumulator 14 to the combustion chamber 22. The sensor 42 may include any sensor configured to sense any operating parameter of the locomotive, such as a speed sensor and a temperature sensor, for example. Also, as illustrated in the exemplary embodiment of FIG. 3, a position determination device 44, such as a global positioning satellite (GPS) system, for example, is positioned on the locomotive, and is configured to determine a position of the locomotive. The controller 40 may be responsive to the sensor 42 and/or the position determination device 44 to vary the variable volume 16 and variable pressure of the accumulator 14 based on a determined location to adjust the variable rate of volumetric flow 24 of fuel 20 from the accumulator 14 to the combustion chamber 22. In an additional exemplary embodiment, the controller 40 may include a memory which stores a volumetric flow 24 profile for each location received from the position determination device 44, and the controller 40 may retrieve a volumetric flow 24 profile for a determined location from the memory. Once the controller 40 has retrieved the volumetric flow 24 profile for the determined location, the controller 40 may enforce the volumetric flow 24 profile in a number of ways, such as fixing the position 34 of the injector valve 32 and varying the variable volume 16 of the accumulator 14 so to achieve the volumetric flow 24 profile, for example. Alternatively, the controller 40 may enforce the volumetric flow 24 profile by fixing the variable volume 16 of the accumulator 14 and varying the position 34 of the injector valve 32 to achieve the volumetric flow 24 profile, for example. In an exemplary embodiment, the variable pressure and the rate of volumetric flow 24 of fuel 20 from the accumulator 14 to the combustion chamber 22 is statically controlled by fixing the variable volume 16 and the position 34 of the injector valve 32 during a combustion event.

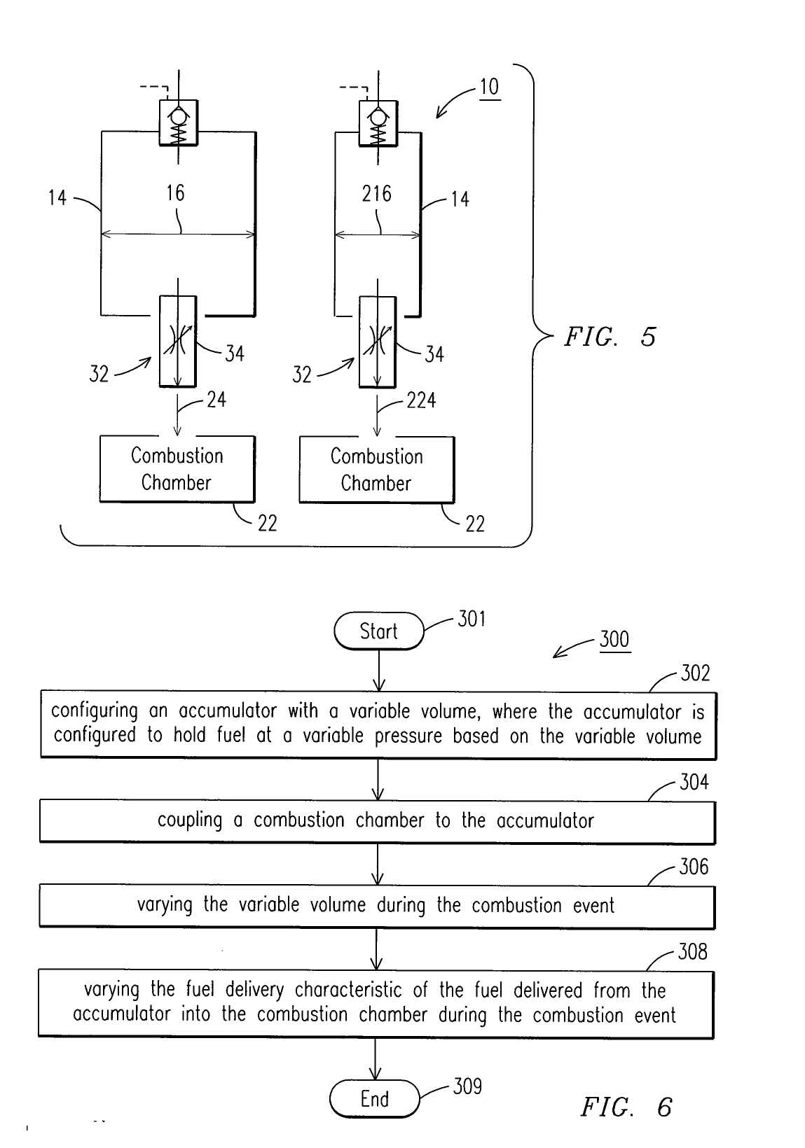

FIG. 5 illustrates an additional exemplary embodiment of a system 10 for controlling a fuel delivery characteristic. Based on the determined location provided by the position determination device 44 to the controller 40, the controller 40 retrieves a volumetric flow 24 profile from the controller memory. Based upon this volumetric flow 24 profile, the controller 40 fixes the injector valve position 34 at a constant, while the controller 40 adjustably varies the variable volume 16 of the accumulator 14 from a first volume 16 to a second volume 216. In the exemplary embodiment of FIG. 5, the second volume 216 is greater than the first volume 16, thereby reducing the variable pressure within the accumulator 14. The variable pressure of fuel 20 within the accumulator 14 is correspondingly varied based on the second volume 216, thereby varying the volumetric flow 24 of fuel 20 into the combustion chamber 22. The relationship between the volumetric flow V of fuel into the combustion chamber, the variable pressure Pₐ of fuel in the accumulator, the pressure P_{c} of the combustion chamber and the fluid density ρ is:

V=\sqrt{2(Pₐ−P_{c})/ρ}

Accordingly, the volumetric flow 24 of fuel 20 to the combustion chamber 22 is varied from a first volumetric flow 24 amount to a second volumetric flow 224 amount, based on the differences in the variable pressures attributed to the variable volumes 16,226 within the accumulator 14.

FIG. 6 illustrates an exemplary embodiment of a method 300 for controlling a fuel delivery characteristic, such as the volumetric flow 24, for example, during a combustion event 26,28,30, within an engine 12 of a locomotive. The method 300 begins at 301 by configuring 302 an accumulator 14 with a variable volume 16, where the accumulator 14 is configured to hold fuel 20 at a variable pressure based on the variable volume 16. The method 300 further includes coupling 304 a combustion chamber 22 to the accumulator 14. Additionally, the method 300 includes varying 306 the variable volume 16 during the combustion event 28, and varying 308 the fuel delivery characteristic of the fuel 20 delivered from the accumulator 14 into the combustion chamber 22 during the combustion event 28, before ending at 309.

Based on the foregoing specification, the above-discussed embodiments of the invention may be implemented using computer programming or engineering techniques including computer software, firmware, hardware or any combination or subset thereof, wherein the technical effect is to control a fuel delivery characteristic during a combustion event within an engine. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

When implementing an embodiment of a system of the present invention, some implementation options include deriving an injection profile analytically, where such a profile may include the number of injections for a given combustion cycle, the flow rate acceleration and damping for each injection stage, a target maximum flow rate for each injection stage, a flow rate deceleration and damping for each injection stage, and a total flow time for each injection stage, among other factors. The profile is typically embedded in the injection controller, which calculates a minimum rail pressure to achieve minimum flow rate requirements at maximum accumulator volume or maximum outlet restriction area for a series of combustion events, for example. The common rail pressure may be controlled to the calculated minimum pressure required for the series of combustion events. The injection controller may utilize the injector solenoid valve to control the number of injection stages and the total flow time for each injection stage and the total flow time of the entire injection event. The injection controller may utilize the variable volume or the variable area control surface to control all other components of the injection profile (Flow rate acceleration and damping, Target maximum flow rate, Flow rate deceleration and damping). The injection profile may be repeated for several combustion events until a new profile is selected and the common rail pressure can be regulated to the new calculated minimum pressure required. In an additional embodiment of the present invention, the implementation options may be similar to those above, but may include a mechanical spring/damper injection system being designed to provide the target rate of change in flow rate for all injection events.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for controlling at least one fuel delivery characteristic during a combustion event within an engine of a locomotive, said system comprising:
an accumulator having a variable volume, said accumulator is configured to hold fuel at a variable pressure based on said variable volume; and
a combustion chamber coupled to said accumulator;
said variable pressure is varied during said combustion event such that at least one fuel delivery characteristic of said fuel delivered from said accumulator into said combustion chamber is varied during said combustion event.

2. The system of claim 1, further comprising an injector valve positioned between said accumulator and said combustion chamber, said injector valve configured to vary a rate of said fuel delivery characteristic from said accumulator into said combustion chamber based on a position of said injector valve relative to said accumulator.

3. The system of claim 2, wherein said position of said injector valve is variable based on said variable pressure of said fuel within said accumulator.

4. The system of claim 3, wherein said fuel delivery characteristic is a volumetric flow of fuel, said volumetric flow of fuel is controlled based on said variable pressure of said fuel within said accumulator, and a rate of volumetric flow of fuel from said accumulator to said combustion chamber is adjustably varied based on said position of said injector valve.

5. The system of claim 4, wherein said variable pressure and said rate of volumetric flow of fuel from said accumulator to said combustion chamber is adjustably varied based on at least one of a dynamic variation of said variable volume and a dynamic variation of said position of said injector valve during said combustion event.

6. The system of claim 4, wherein said variable pressure and said rate of volumetric flow of fuel from said accumulator to said combustion chamber is statically controlled based on fixing said variable volume and said position of said injector valve during said combustion event.

7. The system of claim 4, wherein said volumetric flow of fuel and said rate of volumetric flow of fuel are adjustably varied at a beginning and an end portion of said combustion event such that said rate of volumetric flow of fuel is less than a maximum threshold flow rate.

8. The system of claim 2, further comprising:
a sensor configured to sense an operating parameter of the locomotive;
a controller coupled to said sensor, said accumulator and said injector valve;
said controller configured to vary said position of said injector valve based upon said operating parameter to adjust a variable rate of volumetric flow of fuel from said accumulator to said combustion chamber.

9. The system of claim 8, further comprising a position determination device on said locomotive, said position determination device configured to determine a position of said locomotive;
wherein said controller is responsive to at least one of said sensor and said position determination device to vary said variable volume and variable pressure of said accumulator to adjust said variable rate of volumetric flow of fuel from said accumulator to said combustion chamber.

10. The system of claim 8, wherein said controller is configured to dynamically vary the position of said injector valve during said combustion event to selectively vary said rate of volumetric flow of fuel from said accumulator to said combustion chamber.

11. The system of claim 10, wherein said variable pressure is held constant while said controller dynamically varies said position of said injector valve during said combustion event to selectively vary said rate of volumetric flow of fuel from said accumulator to said combustion chamber.

12. The system of claim 9, wherein said position of said injector valve is held constant while said controller dynamically varies said variable pressure of fuel within said accumulator to adjustably vary said rate of volumetric flow of fuel from said accumulator to said combustion chamber during said combustion event

13. A method for controlling at least one fuel delivery characteristic during a combustion event within an engine of a locomotive, said method comprising:
configuring an accumulator with a variable volume, said accumulator being configured to hold fuel at a variable pressure based on said variable volume;
coupling a combustion chamber to said accumulator;
varying said variable volume during said combustion event; and
varying at least one fuel delivery characteristic of said fuel delivered from said accumulator into said combustion chamber during said combustion event.

14. The method of claim 13, further comprising:
positioning an injector valve between said accumulator and said combustion chamber; and
varying a position of said injector valve relative to said accumulator to vary a rate of said fuel delivery characteristic from said accumulator into said combustion chamber.

15. The method of claim 14, wherein said varying of said position of said injector valve is based on said variable pressure of said fuel within said accumulator.

16. The method of claim 14, wherein said fuel delivery characteristic is a volumetric flow of fuel, said method further comprising:
controlling said volumetric flow of fuel based on said variable pressure of said fuel within said accumulator, and
adjustably varying said rate of volumetric flow of fuel from said accumulator to said combustion chamber based on said position of said injector valve.

17. The method of claim 14, further comprising:
sensing an operating parameter of said locomotive with a sensor on said locomotive;
coupling a controller to said sensor, said accumulator and said injector valve;
varying said position of said injector valve with said controller based upon said operating parameter to adjust a variable rate of volumetric flow of fuel from said accumulator to said combustion chamber.

18. The method of claim 17, further comprising:
determining a position of said locomotive with a position determination device;
coupling said controller to said position determination device;
dynamically varying said variable volume and variable pressure of said accumulator with said controller based upon at least one of said operating parameter and said locomotive position to adjust said variable rate of volumetric flow of fuel from said accumulator to said combustion chamber.

19. The method of claim 17, further comprising:
dynamically varying the position of said injector valve with said controller during said combustion event to selectively vary said rate of volumetric flow of fuel from said accumulator to said combustion chamber.

20. The method of claim 19, further comprising:
fixing said variable pressure at a constant pressure; and
dynamically varying said position of said injector valve with said controller during said combustion event to selectively vary said rate of volumetric flow of fuel from said accumulator to said combustion chamber.

21. The method of claim 18, further comprising:
fixing said position of said injector valve at a constant position; and
dynamically varying said variable pressure of fuel within said accumulator with said controller to adjustably vary said rate of volumetric flow of fuel from said accumulator to said combustion chamber during said combustion event.

22. Computer readable medium containing program instructions for controlling at least one fuel delivery characteristic during a combustion event within an engine, where an accumulator is configured with a variable volume, said accumulator being coupled to a combustion chamber and being configured to hold fuel at a variable pressure based on said variable volume, an injector valve is positioned between said accumulator and said combustion chamber and a controller is coupled to said accumulator and said injector valve, the computer readable medium comprising:
a computer program code for varying said position of said injector valve to adjust a variable rate of volumetric flow of fuel from said accumulator to said combustion chamber, and
a computer program code for varying said variable volume and variable pressure of fuel within said accumulator to adjust said variable rate of volumetric flow of fuel from said accumulator to said combustion chamber.
